(19) United States
(12) Patent Application Publication
(10) Pub. No.: US 2011/0080409 A1
(43) Pub. Date: Apr. 7, 2011

(54) FORMULA INPUT METHOD USING A COMPUTING MEDIUM

(76) Inventor: Hakmin Lee, Seoul (KR)

(21) Appl. No.: 12/991,399

(22) PCT Filed: Jan. 18, 2009
(86) PCT No.: PCT/KR2009/000262

§ 371 Date: Nov. 5, 2010

(30) Foreign Application Priority Data
Jun. 25, 2008 (KR) 10-2008-0060419

(51) Int. Cl. G06T 11/00

(52) U.S. Cl. 345/467

(57) ABSTRACT

The present invention relates to a formula input method using a computing medium, which displays only a corresponding formula in automatic mode in response to a key input, which facilitates formula input as well as creation, editing, revision and deletion of a formula with the aid of an input device such as short-cut keys or a mouse and by providing elements in a formula in the form of independent characters, the elements comprising math symbols, superscripts/subscripts attached to the math symbols, individual characters that belong to the math symbols in a formula and special characters, and which offers management based on the same characteristics of letters, characters and documents within the same field or fields as normal letters to increase user convenience and allow users to express and create a formula with ease.

### TECHNICAL FIELD

The present invention relates, in general, to a formula input method using a computing medium, and, more particularly, to a formula input method using a computing medium, which automatically displays and provides only related formulas in response to the input of a keyword input, enables a formula to be easily entered using an input device, such as a shortcut key or a mouse, and allows formula elements, such as formula symbols, superscripts and/or subscripts to be added to the formula symbols, individual letters subordinate to the formula symbols and special letters, to be provided as independent letters, thereby facilitating the creation, editing, revision and deletion of formulas, and which enables formulas to be managed in the same field as normal letters according to the same letter, character and document characteristics, thereby improving users' convenience and facilitating the representation and creation of formulas.

### BACKGROUND ART

Devices, such as a computer, a portable computer, a mobile communication terminal, and a PDA, are configured to create documents using programs, such as the “Hangul Word Processor” and “MS Word,” or people can create, post and send messages in specific pages over the web, that is, the Internet. Messages created as described above are not necessarily created only in languages, such as Korean and English, but are created to contain a variety of types of content, such as formulas, symbols, and symbols for elements.

Since the formulas among the content require a large amount of input and a complicated input method, word processor programs or web pages use different input methods and provide them to users. Such formula input methods substantially provide additional input/editing functionalities using separate work windows or work pages. Representative formula editors include an expression-type formula editor which, when an expression is entered, converts the expression into a formula and represents the formula in the form of an image, and a toolbar-type formula editor (here, since toolbar-type editor does not have a separate name, a menu selection-type editor is referred to as a toolbar-type editor) which is configured to arrange a variety of possible formulas in a region, such as an icon, a menu or a toolbar, and to allow users to select these.

A representative of the expression-type formula editor is a formula editor which is provided by the “Hangul Word Processor,” which is being widely used in Korea. The formula editor of the “Hangul Word Processor” is configured such that it is possible to select a specific formula from a formula symbol pallet into which formula symbols are grouped and enter it, thereby providing the functionality of a toolbar-type formula editor. However, the most significant characteristic of the formula editor of the “Hangul Word Processor” is that when an expression is created and entered, the expression is converted into a formula and then the formula is provided to a user using a display region. Furthermore, the formula editor of the “Hangul Word Processor” has the functionality for, which the completion of a formula is designated by a user, converting the formula into an image data and inserting the image data into a “Hangul Word Processor” document. The expression-type formula editor has the advantage of representing elaborate and clear formulas, compared with a toolbar-type formula editor, and is advantageous in that users familiar with expressions can enter formulas quickly. However, the expression formula editor is disadvantageous in that it is difficult for beginners to use it and become accustomed to it because an expression which should be entered to express a formula is excessively complicated and the number of keys which should be pressed is excessively large. Furthermore, in the case of the expression-type formula editor, an expression to be input becomes complicated in proportion to the complexity of a formula, so that it is difficult to create a formula quickly and find and correct the error of the created formula. Moreover, when an expression is not created in conformity with preset rules, a formula is not completed, so that there is the advantage of causing great inconvenience in use, as in a toolbar-type formula editor. Furthermore, since rules different from the rules for language letters are used, there is the inconvenience of being well aware of and using the former rules. For example, in order to enter an integral symbol using the expression-type formula editor, an English word, such as “INTEGRAL,” should be entered in an expression input window and “#” should be entered to provide an empty space in a line. Accordingly, the excessive complexity of the procedure for completing a single formula is pointed as a problem. Furthermore, the greatest problem of the expression-type formula editor is that a complete formula is converted into and represented in the form of image data. That is, unlike in the creation of a document, a formula is described in a document in the form of individual letters or letter elements, that is, independent character, but the entire complete formula is converted into a single image. Accordingly, in order to edit a formula, the inconvenience of invoking a formula creator, that is, a formula editor, again and then search for and correcting a portion of an expression which is incorrect or which should be corrected is incurred.

The toolbar-type formula editor is not significantly different from the above-described editor. In particular, in the case of the toolbar-type formula editor, since possible formulas should be classified and arranged in the form of a pallet, a menu or a pop-up, there are the inconvenience of finding and entering a desired item and the problem of causing difficulty in finding a desired item. Moreover, the toolbar-type formula editor is most disadvantageous in that when even a formula has various types of expressions, that is, either when it is necessary to enter one or more limiting values or when only a formula is used without requiring the entry of a limiting value, all formulas should be provided and displayed and a desired formula should be searched for and selected from among the formulas.

### DISCLOSURE

Technical Problem

Accordingly, the present invention has been made keeping in mind the above problems occurring in the prior art, and an object of the present invention is to provide a formula input method using a computing medium, which automatically displays and provides only related formulas in response to the input of a keyword input, enables a formula to be easily entered using an input device, such as a shortcut key or a mouse, and allows formula elements, such as formula symbols, superscripts and/or subscripts to be added to the formula symbols, individual letters subordinate to the formula symbols and special letters, to be provided as independent letters, thereby facilitating the creation, editing, revision and deletion of formulas, and which enables formulas to be managed in the same field as normal letters according to the same letter, character and document characteristics, thereby improving users' convenience and facilitating the representation and creation of formulas.

Technical Solution

In order to accomplish the above object, the present invention provides a formula input method using a computing medium, in which one or more formulas are entered in a web page or a word document using a personal terminal, including a computer terminal, including setting formula keywords representative of formulas using keys of an input device of the personal terminal; activating an input field, that is, an output region, in which information is displayed in response to pressing of the keys of the display device of the personal terminal, and pressing a first key based on a user's manipulation; displaying a letter corresponding to the pressed first key in the input field; determining whether the pressed first key corresponds to one of the formula keywords; if the pressed first key corresponds to one of the formula keywords, displaying formulas corresponding to the formula keyword using the display device in menu form which enables the user to select a formula; pressing a second key identical to or different from the first key using the input device based on the user's manipulation; determining whether the second key is a key used to select a formula displayed in the formula menu; and, if the second key is a key used to select the formula, displaying a formula, selected by the second key, in the input field.

The determining whether the pressed first key corresponds to one of the formula keywords may include, if the first key does not correspond to one of the formula keywords, returning to pressing the first key and then pressing a new first key.

The determining whether the second key is a key used to select a formula may include, if the second key is not a key used to select a formula, displaying a letter corresponding to the second key; and returning to the determining whether the pressed first key corresponds to one of the formula keywords and then waiting for a new second key to be pressed.

The setting formula keywords representative of formulas may include setting common keywords; and grouping formulas which can be invoked using the common keywords.

The grouping formulas may include configuring each of the formulas in different forms, and grouping them.

The setting formula keywords may include installing and running a formula input program for entering the formulas in an application program, including a web page and a word processor program, in which a document containing the formula is created.

The displaying formulas in menu form may include invoking a formula group having the formula keyword corresponding to the first key, and displaying the formula group; wherein the formula menu is provided in pop-up form.

Formula symbols constituting the formula entered in the input field may be displayed in the same field and in the same manner as the letter entered in the input field by the first key, and may be edited and deleted in the same manner as the letter.

Any one of the pressing a new second key, the determining whether the second key is a key used to select a formula, and the displaying the formula in the input field may include displaying a letter corresponding to the second key; if the second key is a key used to select a formula, deleting the displayed letter; and displaying a formula selected by the second key.

Advantageous Effects

The formula input method using a computing medium according to the present invention can automatically display and provide only related formulas in response to the input of a keyword input, enable a formula to be easily entered using an input device, such as a shortcut key or a mouse, and allow formula elements, such as formula symbols, superscripts and/or subscripts added to the formula symbols, individual letters subordinate to the formula symbols and special letters, to be provided as independent letters, thereby facilitating the creation, editing, revision and deletion of formulas, and the formula input method enable formulas to be managed in the same field as normal letters according to the same letter, character and document characteristics, thereby improving users' convenience and facilitating the representation and creation of formulas.

Furthermore, the formula input method using a computing medium according to the present invention can use keywords shorter than commands used in expressions, thereby facilitating the formula input of users, and can use a smaller number of keywords than expressions, thereby increasing users' convenience.

Furthermore, the formula input method using a computing medium according to the present invention does not use expressions but is configured to directly edit formulas to be entered, thereby facilitating the editing of formulas, compared to expressions.

Furthermore, the formula input method using a computing medium according to the present invention is configured to enter a formula in such a way that a user selects one from among formulas presented by a program, thereby reducing the number of errors, compared to the use of expressions, and thereby enabling documents, including formulas, to be quickly and easily created when it is used in combination with a normal input method.

Furthermore, the formula input method using a computing medium according to the present invention enables formulas to be entered using only an input device, such as keyboard, or using a combination of the input device and another input device, such as a mouse, thereby ensuring users' convenient use.

### DESCRIPTION OF DRAWINGS

FIG. 1 is a flowchart showing a formula input method using a computing medium according to the present invention; and

FIGS. 2 to 9 show examples of the actual implementation of the formula input method according to the present invention.

### DESCRIPTION OF PRINCIPAL ELEMENTS IN THE DRAWINGS

100: input field 110: writing region
130: first superscript/subscript region subordinate to parent formula
131: second superscript/subscript region subordinate to parent formula

### MODE FOR INVENTION

The other objects, features and operations of the present invention will be more clearly understood from the following detailed description of embodiments taken in conjunction with the accompanying drawings.

The following detailed description of the invention given in conjunction with the accompanying drawings is presented for the purpose of describing preferred embodiments of the present invention, and does not disclose all practicable embodiments of the present invention. It should be noted that identical or equivalent functionalities included in the sprit or scope of the present invention may be also achieved using other embodiments.

Some features shown in the drawing are expanded for ease of description, and the drawings and components thereof are not necessary illustrated in the appropriate scale. However, those skilled in the art can easily understand the above details.

Embodiments of the present invention will be described in detail below with reference to the accompanying drawings.

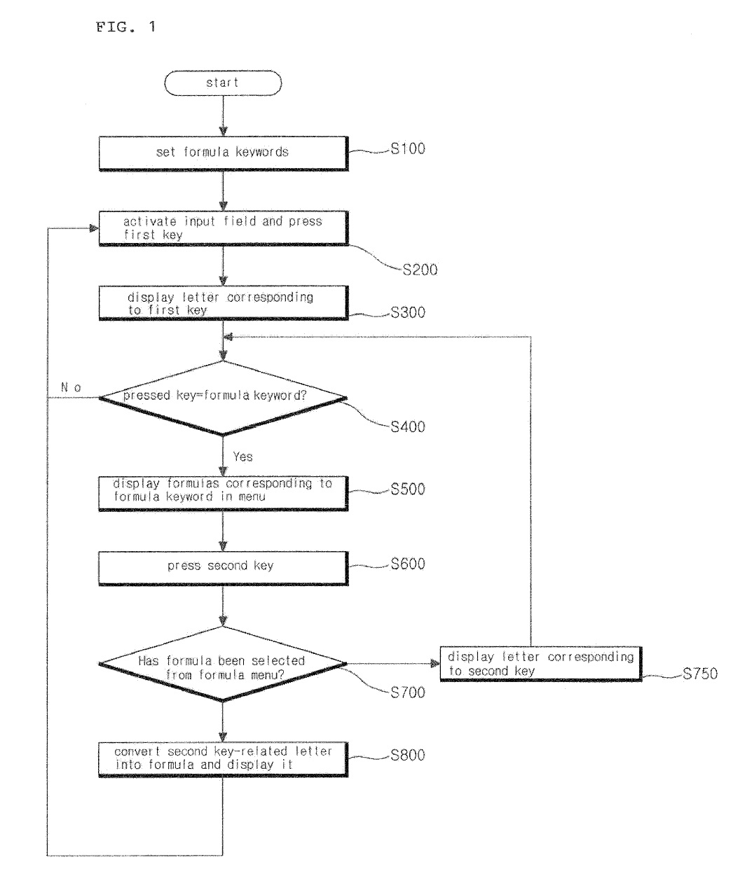

FIG. 1 is a flowchart showing a formula input method using a computing medium according to the present invention.

Referring to FIG. 1, the formula input method using a computing medium according to the present invention includes a formula keyword setting step S100, an input field activation and first key input step S200, a key-related character output step S300, a formula keyword determination step S400, a formula keyword-related formula menu display step S500, a second key input step S600, a formula selection determination step S700, and a selected formula output step S800.

The formula keyword setting step S100 is the step of grouping formulas according to common formula keywords and individualizing the formulas according to their uses. Furthermore, the formula keyword setting step S100 includes the step of installing and executing programs, such as applets or active content, which are used to apply the formula input method according to the present invention. In particular, the formula input method according to the present invention can be easily applied to and used in conjunction with word processor programs including a Word program, presentation programs, and web pages which were previously completed and distributed. For this purpose, it is possible to write a formula input program in an object-oriented language, such as Java, add the formula input program to an existing program in the form of an applet, and then use it. Furthermore, it is possible to convert a formula input program into one of a variety of types of software programs, such as source codes, a plug-in, and a subroutine, in addition to an applet.

The formulas grouped and individualized at the formula keyword setting step S100 will now be described in greater detail. Although it is preferable to represent formula keywords in English because the names of the formulas are represented in English, the present invention is not limited thereto. For convenience of description, the following description is limited to the case where formula keywords are presented by English lowercase letters. Some Greek letters and special characters as well as formulas may be presented by the formula keywords. For example, “A” or “α (alpha)” may be represented by the English letter “a”. That is, it is possible to allow a user to select one of “A” and “α” using a menu when the user types the English letter “a” in an input field. Furthermore, the English letter “r” may be made to represent any one of the square root and the Greek letter “ρ (rho)”. In these cases, the formula keywords are “a” and “r.” Furthermore, with respect to the formula keyword “r,” the square root and “ρ” are bound into a single formula group formula. Furthermore, the expression of the square root may vary depending on the location of a superscript and/or a subscript. In the case of Σ used to calculate a sum, only a symbol itself may be used or a symbol may be used along with a superscript and/or a subscript. Accordingly, in light of this, even a single formula is subdivided depending on the type of use and then provided, which may be referred to as the individualization of the formula. The formulas individualized as described above are grouped for a single formula keyword, and then provided.

At the input field activation and first key input step S200, a field which enables a letter to be output to the user using a display screen is provided, and a letter is entered using the input device of a terminal device. The input field capable of displaying a letter includes a word program, a web page, the message board of a web page, and an equivalent program. Here, the first key is the key button of an input device, that is, a keyboard, which is desired by the user. Furthermore, the first key is a term which is used to distinguish between the first key and a second key which will be described later and which is not used to indicate a sequential position.

The key-related character output step S300 is the step of, when the user presses a key using an input device, displaying the letter corresponding to the key in the input field of a display device or performing functionality. That is, when the key corresponding to “a” is pressed using an input device, such as a keyboard, “a” is displayed in the input field of a display screen.

At the formula keyword determination step S400, when the user presses a first key using an input device, it is determined whether the pressed first key is a key corresponding to a formula keyword. If, as a result of the determination, the pressed first key is not a key corresponding to a formula keyword, a cursor moves to a subsequent input space, and waits for a subsequent first key to be pressed.

The formula keyword-related formula menu display step S500 is the step of, if it is determined that the first key pressed at the above-described formula keyword determination step S400 is a key corresponding to a formula keyword, invoking the formula group corresponding to the first key, that is, an entered formula keyword, in the form of a menu and displaying the menu in a portion of the input field or the screen. Here, the menu may be invoked and displayed in the form of a pop-up. That is, when the letter corresponding to the first key is “a,” “α” and “A” grouped for the first key may be displayed as a pop-up menu from which a selection can be made by the user.

At the second key input step S600, when the formula group is invoked and provided, the user may select a formula from the formula group or enter a different letter in the input field instead of selecting a formula. In order to perform a selection, the user presses a second key using the input device. In greater detail, when the user enters “a” in the input field using the first key, “α” and “A” are displayed in the form of a formula pop-up. At this time, the user selects one from among “α” and “A” or enters a different letter instead of selecting any one from among them by pressing the second key.

The formula selection determination step S700 is the step of determining whether the second key pressed by the user is a key used to select a formula. That is, if the second key pressed by the user does not correspond to a formula of the formula group displayed in the pop-up menu, the second key is considered to be a first key and the letter corresponding to the first is simply entered and displayed in the input field at step S750. Furthermore, if the second key is not a key used to select a formula, the process returns to the formula keyword determination step S400 of determining whether the first key pressed by the user using the input device corresponds to a formula keyword, and waits for a first key to be pressed. If the user does not press a second key used to select a formula, the above-described process will be repeated.

In contrast, if the second key is a key used to select a formula, unlike the first key, the formula is displayed at a subsequent step. Here, it is possible to implement the key used to select a formula by adding functionality to a specific device of the input device. Furthermore, it is possible to select a formula using a shortcut key which is a combination of a special key, such as “Ctrl” or “Alt” and a number key or a function key from F1 to F12. Furthermore, when an additional input device, such as a mouse or a trackball, is present, the second key used to select a formula may be a mouse cursor or a mouse button.

The selected formula output step S800 is the step of, when a formula is selected from the popped up formula group using the second key, displaying the formula in the input field. At this step, the selected formula is displayed in the input field in the same manner as a normal letter, unlike in the conventional technology. That is, a formula is not displayed in the form of an image, unlike in the conventional technology. Instead, each character of the formula occupies a space similar to the space occupied by a single letter or a single character, and the formula is displayed in the input field in the same manner as normal text.

As an example,

in the case of x²+x−1=10,

in the conventional technologies, the formula is processed in the form of an image, so that it is difficult to revise individual letters thereof. In contrast, in the present invention, the formula is displayed in the form of

x²+x−1=10,

but is divided into “x, 2, +, x, +, 1, =, and 10” and then displayed. At this formula output step S800, if the second key input by the user is not a formula selection key, the letter corresponding to the second key is displayed and represented in the input field so that the user can recognize it. If the second key is a formula selection key, the output corresponding letter is replaced with a formula and then displayed, so that the second key is converted into a formula and then displayed. That is, at the formula output step S800, the displayed character corresponding to the first key is deleted and the formula selected by the second key is displayed in the space where the corresponding letter is displayed, so that a representation of the formula is created. Furthermore, when the formula selected by the second key is entered in the input field, the step of waiting for a subsequent key to be pressed is performed and then the above-described process is repeated, so that documents in which normal letters and formulas are mixed together can be written and it is possible to enter formula without using a separate formula editor.

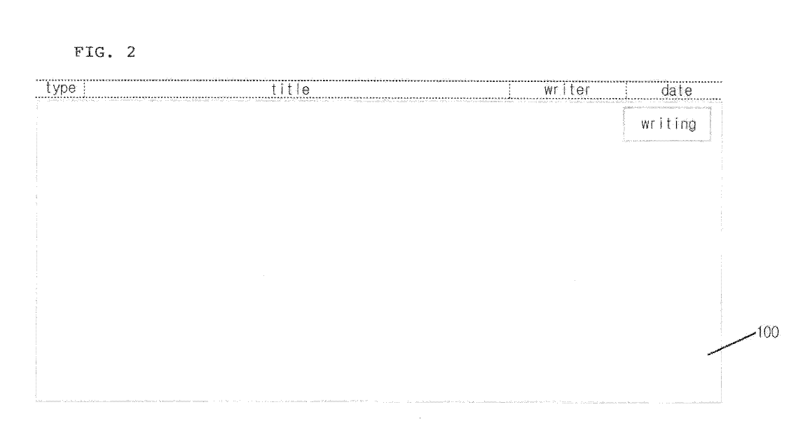

FIGS. 2 to 9 show examples of the actual implementation of the formula input method according to the present invention, and are diagrams showing examples which are used to illustrate the present invention in greater detail.

Referring to FIGS. 2 to 9, FIGS. 2 to 9 are drawings which are used to illustrate a method of inputting letters and formulas using a message board-type web page as an example.

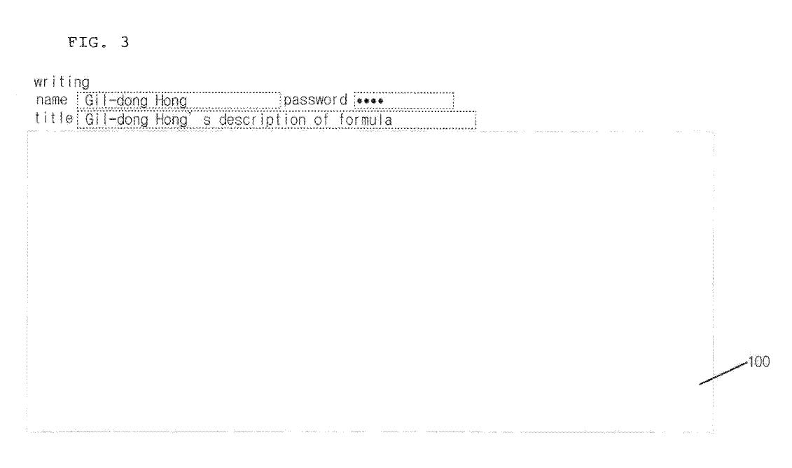

Once a user accesses the message board pages of a specific website, a page in which the user can view a list of messages and the titles and posted dates of the messages is provided, as shown in FIG. 2. When the user clicks a writing button to post a message, a screen such as that shown in FIG. 3 is provided to the user.

FIG. 3 shows a screen in which basic information for writing will be entered. As shown in this drawing, the fields in which the name of a person who posts a message, a password required to authorize revision and deletion, and a title will be entered are provided. After the user has entered appropriate content in the corresponding fields, he or she posts a message in an input field 100.

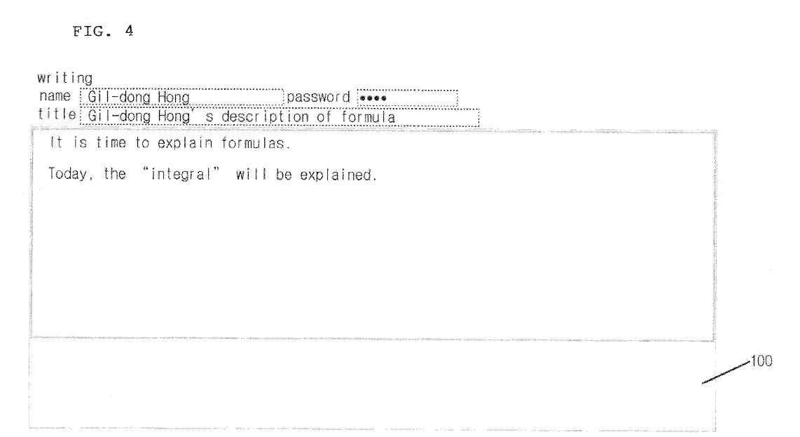

Once the user has completed additional input, such as the entry of a title, the user creates a message by entering the message in the input field, as shown in FIG. 4. FIG. 4 illustrates the user writing a message which describes a formula. As shown in FIG. 4, the user first creates a document using normal letters, that is, language letters.

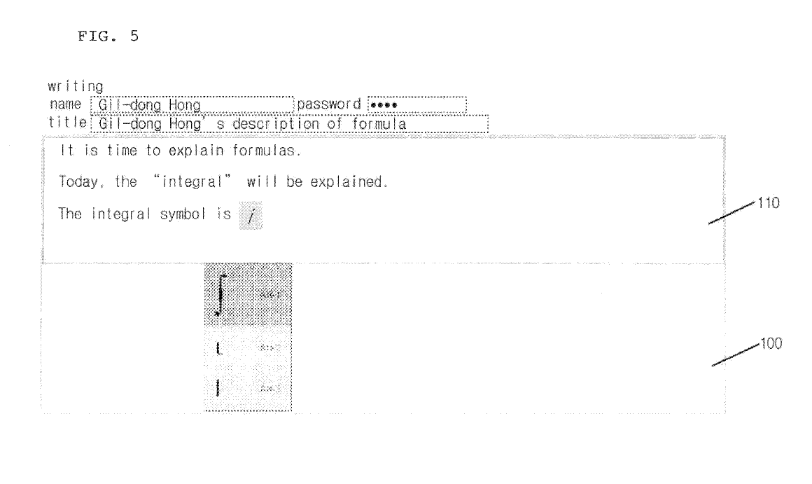

When a location in which a formula should be entered is reached when writing a document, as shown in FIG. 5, the user enters a formula keyword corresponding to a formula which the user desires to invoke. Here, the sentences entered in the writing region 110 of the writing input field 100 are all the text which was entered using the first keys, as described in conjunction with the above-described FIG. 1. When the user enters “i”, which is the first letter of a English word having a meaning of “integral” using a first key in order to enter a formula, symbols grouped for “i” are arranged in the input field 100. In order to enter an integral symbol among the arranged formulas and symbols, the user may press the key combination “Alt+1” corresponding to a second key or may locate a mouse cursor on an integral symbol and click the symbol.

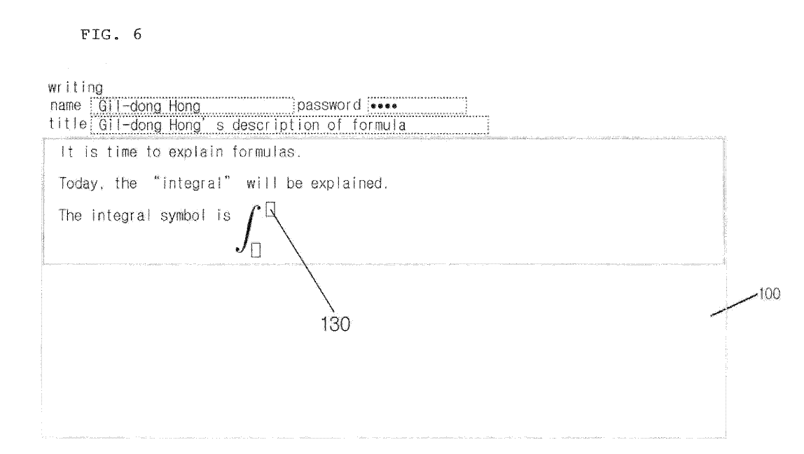

Accordingly, the integral symbol is entered in the writing region of the input field 100, as shown in FIG. 6, and a first superscript/subscript region 130 used to enter a range onto one side of the integral symbol is activated. Here, the first superscript/subscript region 130 of FIG. 6 is configured to indicate an input location in connection with the integral symbol, and is represented as a separate configuration.

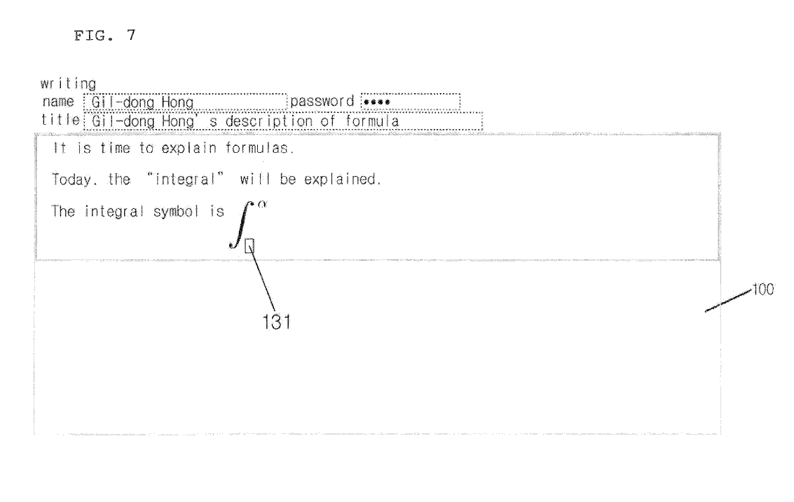

When the user enters a specific letter in the first superscript/subscript region 130, a second superscript/subscript region 131 is activated, as shown in FIG. 7, so that another limiting value can be entered. At least one of these superscript/subscript regions 130 and 131 is activated depending on a selected formula symbol, or only a formula symbol without a superscript/subscript region may be displayed and used.

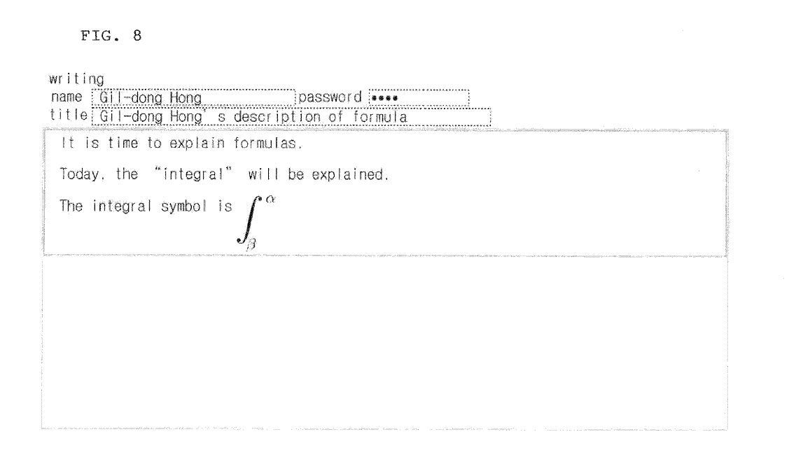

When the first superscript/subscript region 130 and the second superscript/subscript region 131 are filled out, the integral symbol with a superscript and a subscript is displayed in the input region 100, as shown in FIG. 8.

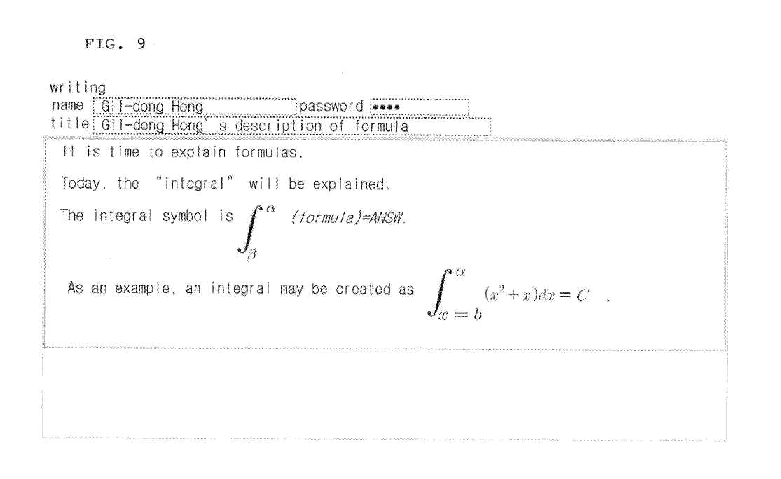

A message, such as that shown in FIG. 9, can be completed by repeating the same method.

As described above, the formula input method according to the present invention allows the formula symbols of the entire formula to be recognized as independent letters, that is, text, thereby facilitating creation, revision, editing and deletion, with the result that it is possible for the user to conveniently use it. Furthermore, the formula editing functionality is implemented in the input field in the form of an applet without requiring the running of a separate formula editing program, so that the present invention has the advantage of considerably facilitating the creation of documents, compared to the conventional technologies.

1. A formula input method using a computing medium, in which one or more formulas are entered in a web page or a word document using a personal terminal, including a computer terminal, comprising:
setting formula keywords representative of formulas using keys of an input device of the personal terminal; activating an input field, that is, an output region, in which information is displayed in response to pressing of the keys of the display device of the personal terminal, and pressing a first key based on a user's manipulation;
displaying a letter corresponding to the pressed first key in the input field; determining whether the pressed first key corresponds to one of the formula keywords; if the pressed first key corresponds to one of the formula keywords, displaying formulas corresponding to the formula keyword using the display device in menu form which enables the user to select a formula; pressing a second key identical to or different from the first key using the input device based on the user's manipulation; determining whether the second key is a key used to select a formula displayed in the formula menu; and, if the second key is a key used to select the formula, displaying a formula, selected by the second key, in the input field.

2. The formula input method according to claim 1, wherein the determining whether the pressed first key corresponds to one of the formula keywords comprises:
if the first key does not correspond to one of the formula keywords, returning to pressing the first key and then pressing a new first key.

3. The formula input method according to claim 1, wherein the determining whether the second key is a key used to select a formula comprises:
if the second key is not a key used to select a formula, displaying a letter corresponding to the second key; and returning to the determining whether the pressed first key corresponds to one of the formula keywords and then waiting for a new second key to be pressed.

4. The formula input method according to claim 1, wherein the setting formula keywords representative of formulas comprises:
setting common keywords; and grouping formulas which can be invoked using the common keywords.

5. The formula input method according to claim 4, wherein the grouping formulas comprises:
configuring each of the formulas in different forms, and grouping them.

6. The formula input method according to claim 1, wherein the setting formula keywords comprises:
installing and running a formula input program for entering the formulas in an application program, including a web page and a word processor program, in which a document containing the formula is created.

7. The formula input method according to claim 1, wherein the displaying formulas in menu form comprises:
invoking a formula group having the formula keyword corresponding to the first key, and displaying the formula group;
wherein the formula menu is provided in pop-up form.

8. The formula input method according to claim 1, wherein formula symbols constituting the formula entered in the input field are displayed in a same field and in a same manner as the letter entered in the input field by the pressing of the first key, and are edited and deleted in a same manner as the letter.

9. The formula input method according to claim 1, wherein any one of the pressing a new second key, the determining whether the second key is a key used to select a formula, and the displaying the formula in the input field comprises:
displaying a letter corresponding to the second key; if the second key is a key used to select a formula, deleting the displayed letter; and displaying a formula selected by the second key.
